(19) United States
(12) Patent Application Publication
(10) Pub. No.: US 2004/0025901 A1
(43) Pub. Date: Feb. 12, 2004

(54) Stationary wafer spin/spray processor

(75) Inventors: Eric J. Bergman, Kalispell, MT (US); Jeffrey J. Dennison, Kalispell, MT (US); David P. Surdock, Fulbourn, MT (US)

Correspondence Address: PERKINS COIE LLP, POST OFFICE BOX 1208, SEATTLE, WA, 98111-1208, US

(73) Assignee: Semitool, Inc.

(21) Appl. No.: 10/631,378

(22) Filed: Jul. 30, 2003

Related U.S. Application Data
(63) Continuation-in-part of application No. 09/907,485, filed on Jul. 16, 2001.
(63) Continuation-in-part of application No. 09/907,544, filed on Jul. 16, 2001.

(51) Int. Cl. B08B 3/12

(52) U.S. Cl. 134/1; 134/25.4; 134/34; 134/30; 134/95.2; 134/172; 134/184

(57) ABSTRACT

A system and method for processing a workpiece, such as a semiconductor wafer, includes a spray mechanism that rotates around the workpiece while the workpiece rests on a stationary workpiece support in a process chamber. The spray mechanism preferably includes one or more spray arms attached to a motorized rotary union via hollow elbow sections. The rotary union is attached to a fluid supply valve and preferably includes a hollow shaft through which process fluid may travel from the fluid supply valve to the spray arms. The process chamber includes a drain through which process fluid may be removed from the process chamber. A process gas and/or vapor manifold, a sonic transducer, and/or a rinsing liquid manifold may be included in the process chamber for delivering a process gas or vapor, sonic energy, and/or a rinsing liquid into the process chamber in order to enhance processing of the workpiece.

This Application is a Continuation-In-Part of each of U.S. patent application Ser. Nos. 09/907,485 and 09/907,544, both filed on Jul. 16, 2001 and now pending. These Applications are incorporated herein by reference.

### BACKGROUND OF THE INVENTION

The invention relates to surface preparation of a workpiece, such as silicon or gallium arsenide wafers, flat panel displays, mask reticles, rigid disk media, thin film heads, or other substrates on which electronic, optical, or micro-mechanical components have or can be formed, collectively referred to here singly as a “wafer” or “workpiece”.

Surface preparation, such as cleaning, etching, and stripping, is an essential and important element of the manufacturing process for semiconductor devices. Surface preparation steps are commonly performed using liquid corrosive, caustic, or solvent chemicals, or using vapor or gas phase chemicals. Surface preparation of workpieces is performed to “prepare” or “condition” the surface for a subsequent process step.

Spin-spray techniques are often used to process a batch of workpieces. A typical spin-spray technique involves securing a batch of workpieces onto a rotor with retaining bars, and then spinning the rotor while process fluids are sprayed toward the wafers on the rotor. This technique may require as little as four liters of process fluid (or less) to process a batch of wafers.

While existing spin-spray techniques have been successful, disadvantages remain. For example, there is a potential for workpiece breakage due to point stresses created where the workpieces are forced against the retaining surfaces of the rotor. Additionally, the workpiece surfaces may flex, and particles may be generated, when the workpiece edges move against the retaining surfaces. Particles from these edge defects may subsequently be distributed across the workpiece surface in subsequent processes. Moreover, while spinning of the workpieces does not in and of itself produce workpiece breakage, chipped, damaged, or highly stressed workpieces may break during rotation, resulting in loose fragments which in turn may cause breakage of additional workpieces.

Despite theses potential drawbacks, spin-spray processes have significant advantages, including the capability to process batches of workpieces with minimal chemical volumes, excellent process uniformity, and consistently delivering fresh chemical to the workpiece surface while preventing stagnation of, and promoting the exchange of, the liquid boundary layer at the workpiece surface. In contrast, processing techniques such as immersion do not require spinning of the workpieces, and largely avoid risks of workpiece breakage. However, immersion consumes much larger amounts of chemicals and water, and is also generally slower.

Thus, there is a need for a processing systems and methods that achieve the benefits of existing spin-spray techniques, while reducing or eliminating the potential problems associated with spinning workpieces.

### SUMMARY OF THE INVENTION

The long standing problems described above have now been solved by a new workpiece processing system where the workpieces remain fixed on a support or holder, while spray elements or other fluid delivery means rotate about the workpieces. The advantages of both immersion and spin-spray processing can now be achieved. Typical designs in the semiconductor manufacturing industry have fixed spray nozzles. Spray nozzles are often attached to a manifold or pipe on or in a wall of a process chamber. By discarding these known designs, and by approaching the problems described above from an entirely new point of view, the inventors have developed a new system and method for overcoming the disadvantages of the existing systems, machines and techniques which are now being used.

The invention may be used by having one or more rotatable spray arms or other fluid delivery element in a process chamber. The spray arms revolve around, and simultaneously spray or otherwise deliver process fluids onto, workpieces supported on a workpiece support in the process chamber.

The invention may also be provided in the form of a system for processing a workpiece having a process chamber, a workpiece support in the process chamber, and a spray or fluid delivery element rotatable around the workpiece support for delivering a process fluid to one or more workpieces positioned on the workpiece support. The fluid delivery element preferably comprises one or more spray arms, each having spray nozzles or other openings through which fluid is delivered. The advantages of spin-spray processing are achieved, without the potential for workpiece breakage and contamination caused by spinning the wafers.

In another separate feature of the invention, the workpiece support is stationary and has a cantilevered arm attached to a wall of the process chamber. The fluid delivery element can then rotate 360 degrees around the cantilevered arm. Several rotatable arms may be cylindrically arranged around the stationary workpiece support to spray or otherwise deliver a process fluid from multiple directions toward the stationary workpiece support. The workpieces are preferably upright or vertical (or near vertical) and the spray arms preferably rotate about a horizontal (or near horizontal) axis.

A method of processing a workpiece includes the steps of placing a workpiece onto a workpiece support in a process chamber, rotating a spray arm or other fluid delivery element around the workpiece, and directing a process fluid from the fluid delivery element onto the workpiece while the fluid delivery element rotates.

Further embodiments, including modifications, variations, and enhancements of the invention, will become apparent. The invention resides as well in subcombinations of the features shown and described.

It is an object of the invention to provide an improved spin-spray processing system and method.

### BRIEF DESCRIPTION OF THE DRAWINGS

In the drawings, wherein the same reference number indicates the same element throughout the several views:

FIG. 1 is a perspective view of a workpiece processing system according to a preferred embodiment.

FIG. 2 is a front view of the workpiece processing system of FIG. 1.

FIG. 3 is a side view of the workpiece processing system of FIGS. 1 and 2.

FIG. 4 is a diagrammatic view of a preferred workpiece processing chamber having a pair of rotatable spray arms.

FIG. 5 is a perspective view of the workpiece processing chamber of FIG. 4.

FIG. 6 is a rear cutaway view of the workpiece processing chamber of FIGS. 4 and 5.

FIG. 7A is a perspective view of a spray mechanism comprising a single spray arm.

FIG. 7B is a perspective view of a spray mechanism comprising two spray arms.

FIG. 7C is a perspective view of a spray mechanism comprising four spray arms.

### DETAILED DESCRIPTION OF THE DRAWINGS

A workpiece support in a process chamber holds workpieces, either directly or by holding a carrier containing workpieces. One or more fluid delivery or spray elements move around the workpiece support to deliver or spray processing fluid onto the workpieces to clean and/or process the workpieces. Other steps and features described below may be advantageous but are not necessarily essential to the invention.

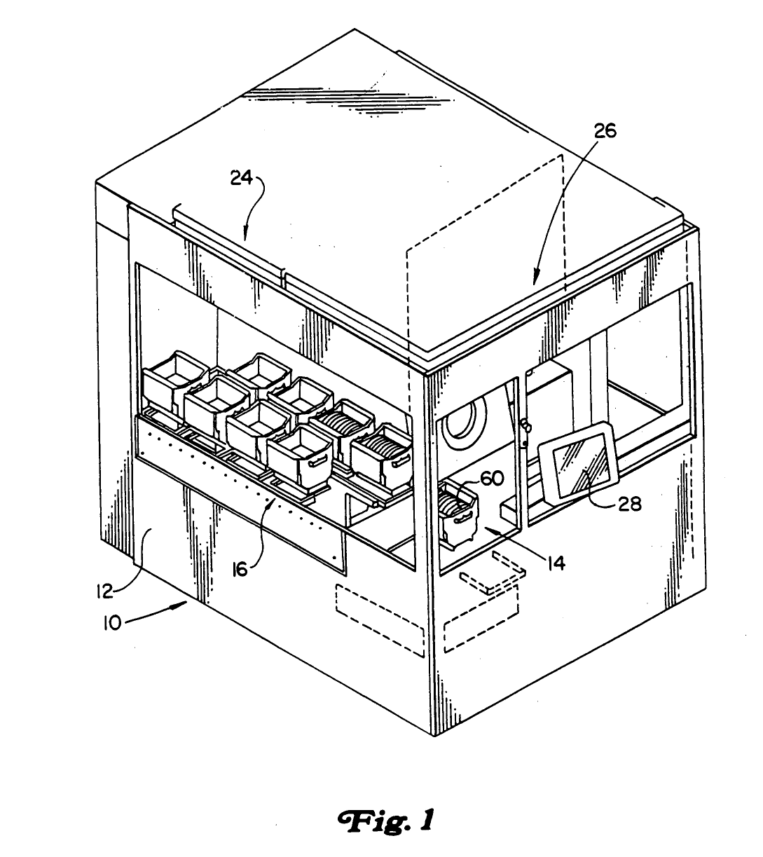

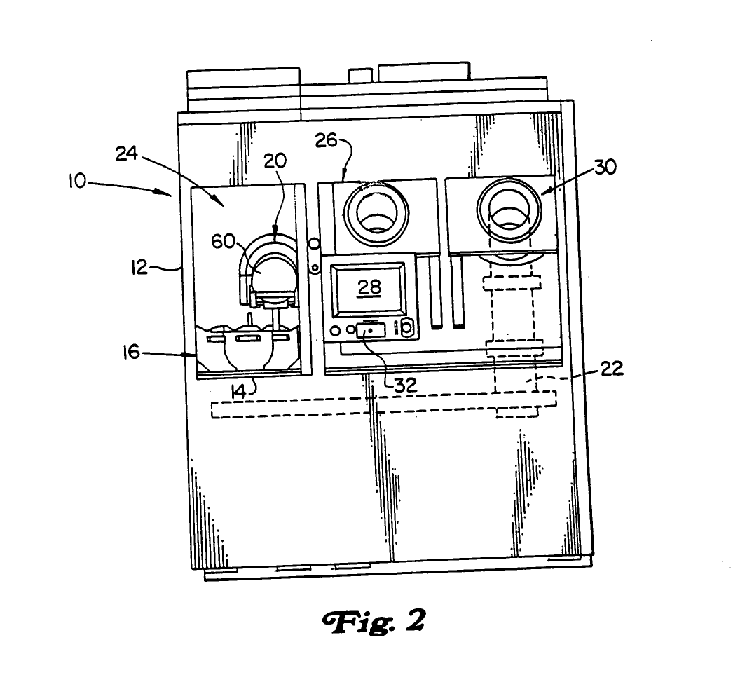

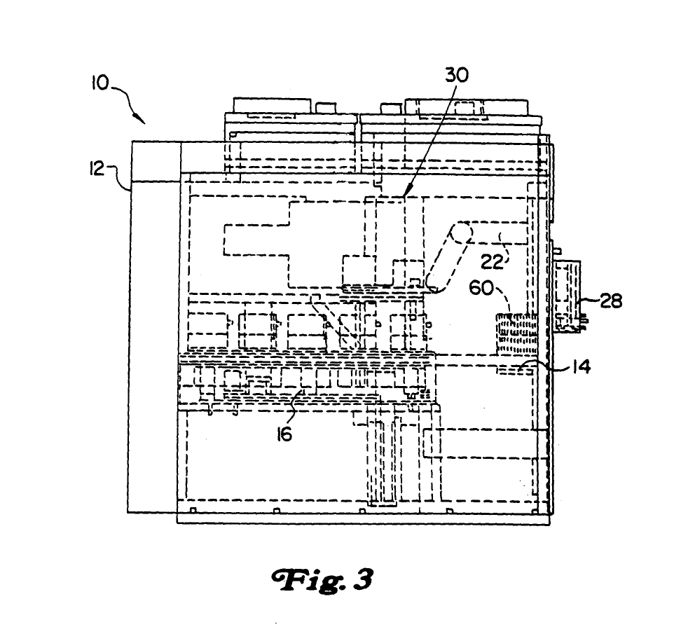

Turning now in detail to the drawings, as shown in FIGS. 1-3, a surface processing system 10 preferably includes an enclosure 12 to maintain and control clean airflow and reduce contamination of workpieces. An input/output station 14 at the front of the system 10 allows workpieces 60 to be loaded and unloaded to and from the system 10. An indexer 16, or other temporary workpiece storage station, is provided adjacent to the input/output station 14.

The system 10 is preferably divided into an interface section 24 and a process section 26. These sections are optimally separated by a partition having a door opening. The interface section 24 includes the input/output station 14 and the indexer 16. The process section 26 includes one or more process stations 30, with each process station 30 including a processor. The interface section 24 also includes a process robot 22 for moving workpieces between the indexer 16 and the processor unit. A control panel 28 may be provided on the enclosure 12, to allow instructions or programming to be input into a computer controller 32 which controls the system 10.

Workpieces 60 may be provided in open carriers, cassettes, or trays, and handled as described in U.S. Pat. No. 6,279,724, incorporated herein by reference. Alternatively, the workpieces 60 may be provided within sealed pods or containers which are unsealed at a docking station, as described in U.S. Pat. No. 6,447,232 or U.S. patent application Ser. No. 09/612,009, both incorporated herein by reference.

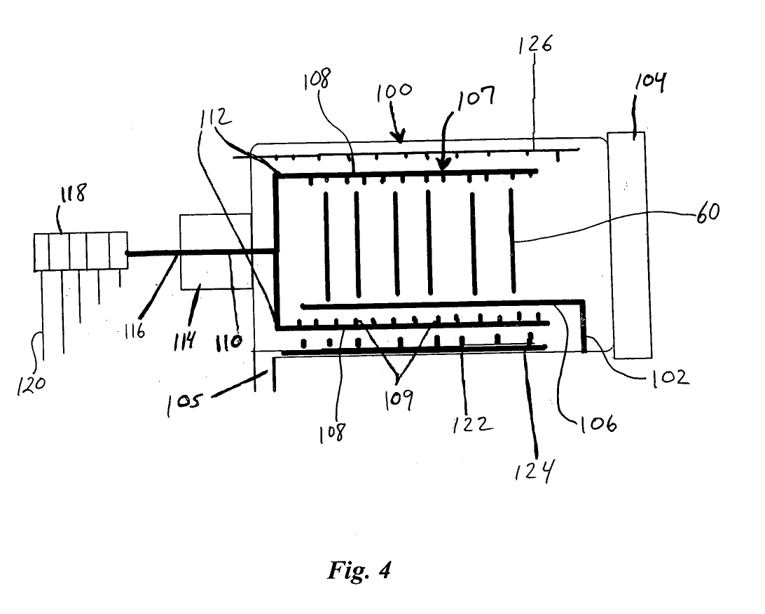

One or more of the processor units include a process chamber 100, illustrated in FIGS. 4-6, having a stationary workpiece support 102 therein. The process chamber includes a removable and/or openable door 104, through which workpieces and/or workpiece carriers may be loaded to and from the process chamber 100. The door 104, when closed, preferably forms a seal with the process chamber 100 so that contaminants are isolated from the process chamber 100 and the process chamber is liquid tight. The bottom surface of the process chamber 100 preferably includes a drain 105 through which process fluids and rinsing liquids may be removed.

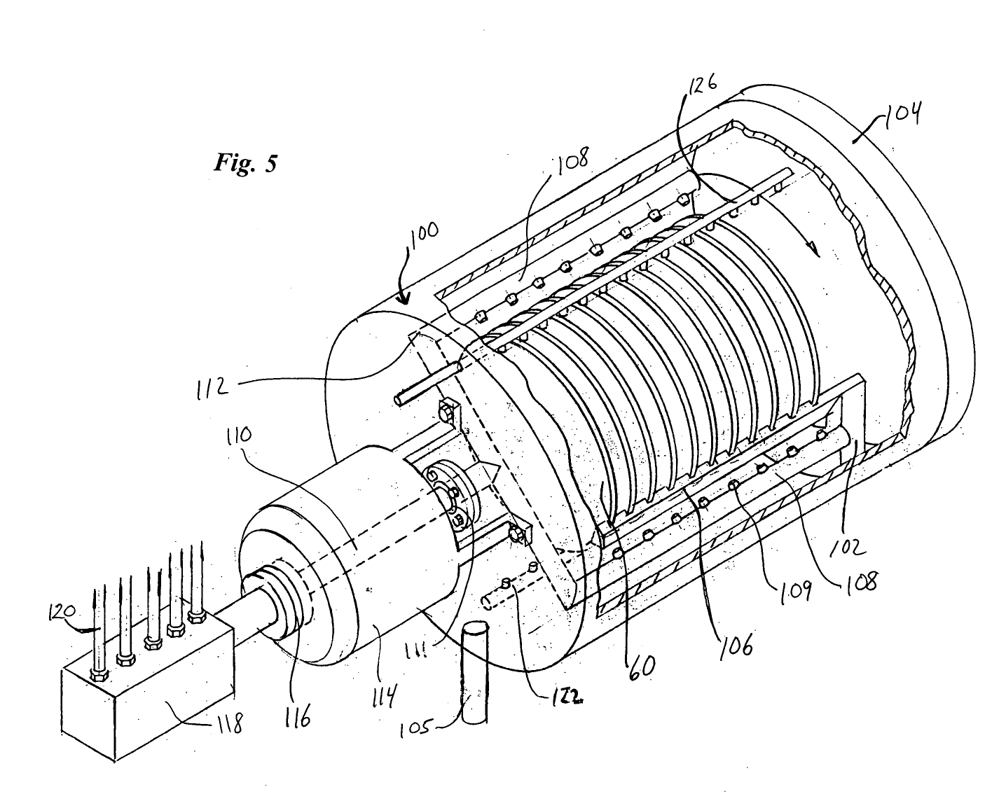

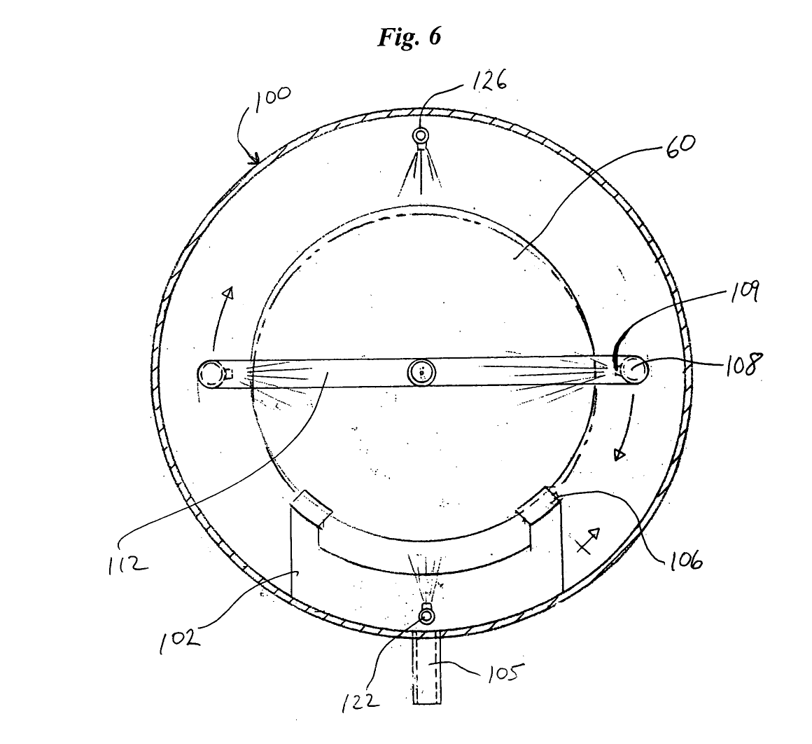

The stationary workpiece support 102 preferably has one or more cantilevered arms 106 extending horizontally in the process chamber 100 for holding workpieces 60 and/or workpiece carriers in a vertical orientation. Two arms 106 for holding workpieces and/or workpiece carriers are illustrated in FIGS. 5 and 6. The workpiece support 102 may alternatively comprise any other structure suitable for holding workpieces and/or workpiece carriers. Regardless of its form, the workpiece support 102 (as well as a workpiece carrier, if used) preferably have a minimal cross-sectional area to reduce blockage of process fluid sprayed toward the workpieces.

The arms 106 of the workpiece support 102 preferably include grooves or notches, typically equally spaced apart, for holding the workpieces 60. The workpiece support 102 may alternatively, or additionally, have features for holding a carrier tray or cassette containing workpieces 60. The workpiece support is preferably configured to handle multiple workpiece sizes, such as 200 mm or 300 mm diameter semiconductor wafers.

The stationary workpiece support 102 is preferably attached to a bottom surface of the process chamber 100, as illustrated in FIGS. 4-6. Alternatively, it may be supported on or attached to an inner surface of the door 104, or to any other suitable location in the process chamber 100. In the embodiment where the stationary workpiece support 102 is attached to a bottom surface of the process chamber 100, the cantilevered arms 106 are preferably attached to a support base of the workpiece support 102 at an approximately 90 degree angle, such that the cantilevered arms 106 extend horizontally within the process chamber 100. Depending on the robotics used, (if any), the support 102 may be on the door 104, as part of a sub-system separate from the chamber.

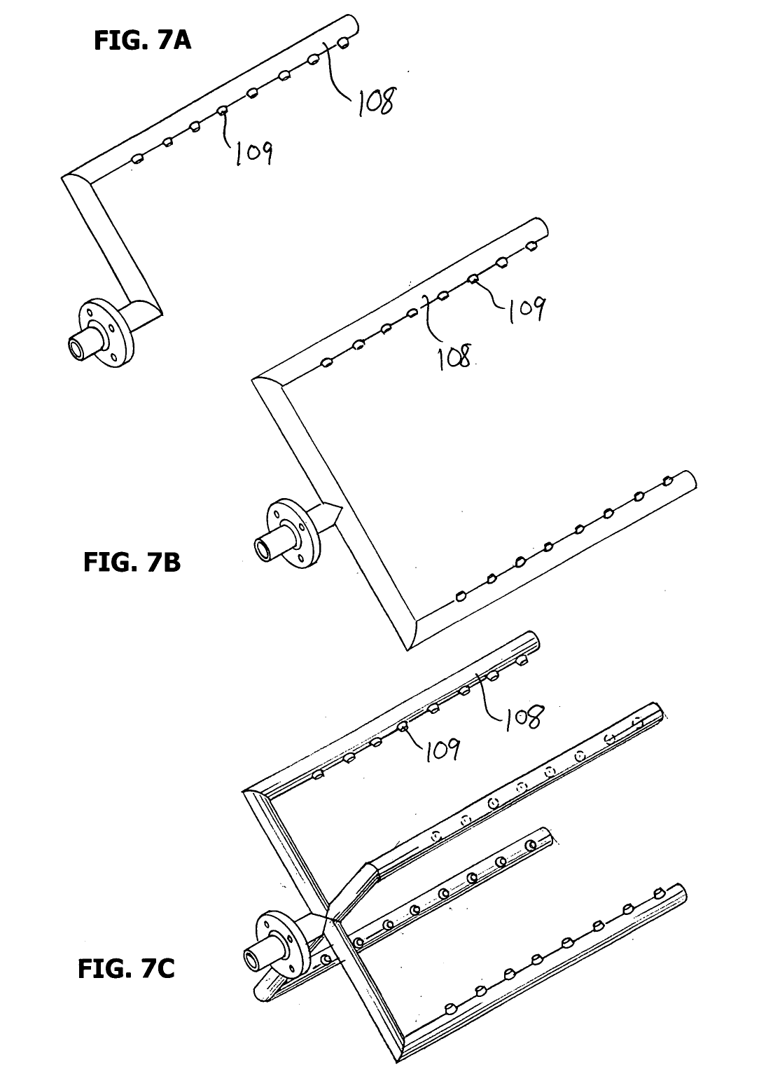

A fluid delivery mechanism 107, which preferably includes one or more hollow spray arms 108, is located in the process chamber 100. In FIGS. 4-6, a spray mechanism 107 having two spray arms 108 is illustrated in the process chamber 100, although the spray mechanism 107 may include any suitable number of spray arms 108. FIGS. 7A-7C illustrate three possible spray mechanism configurations, wherein the spray mechanism includes one spray arm 108, two spray arms 108, and four spray arms 108, respectively.

Each spray arm 108 preferably includes a plurality of openings or nozzles 109 on an inner surface thereof for applying or spraying processing fluids onto workpieces 60 on the workpiece support 102. The arms 108 may alternatively include a longitudinal slit or channel through which fluid may be delivered to workpieces 60 positioned on the workpiece support 102. In such an embodiment, a sheet or cascade of water may be delivered from the fluid delivery mechanism to the workpieces 60. Thus, while spraying fluid via nozzles 109 is preferred, fluid may alternatively be delivered to the workpieces 60 through openings or slits in the fluid delivery mechanism. Accordingly, while spray arms having nozzles will be described throughout the specification, it is to be understood that other means for delivering fluid to the workpieces 60 may alternatively or additionally be used.

In the embodiment illustrated in FIGS. 4-6, two spray arms 108 are positioned on opposite sides of the workpiece support 102. The nozzles 109 on one of the spray arms 108 are substantially aligned with the nozzles 109 on the other spray arm 108. Accordingly, fluids may be concurrently sprayed onto opposite sides of the workpieces 60.

The processing fluids used to process the workpieces 60 may include a cleaning liquid such as hydrofluoric acid (HF), a rinsing liquid such as water, or any other suitable processing fluids. The term processing fluids here also includes vapors and gases, such as ozone, in addition to liquids. Any processing fluids typically used to clean and process workpieces, such as semiconductor wafers, may be used in the processing system 10, as well as any other suitable fluids.

Each of the spray arms 108 is preferably connected to a hollow rotor shaft 110 via a hollow elbow section 112. A fluid delivery line is preferably located in the hollow rotor shaft 110 for delivering fluid to the spray arms 108. The fluid delivery line may run all the way to the nozzles 109, or may terminate at the elbow section(s) 112 of the spray mechanism.

The rotor shaft 110 passes through an opening in an outer wall of the process chamber 100. A seal 111 is preferably located around the shaft 110 at the opening to provide a liquid tight environment within the process chamber. The rotor shaft 110 preferably further passes through a drive motor 114 or actuator, which may be attached to the outer wall of the process chamber 100, as illustrated in FIG. 5.

The rotor shaft 110 is preferably linked to the drive motor 114 by a rotary union 116, or similar coupling, typically connected at the rear of the motor 114. The motor 114 drives the rotary union 116, which turns the rotor shaft 110 and the spray arms 108. The motor requirement is greatly reduced as compared to existing spin-spray processing systems, since the motor only has to drive one or more spray arms 108, as opposed to an entire Teflon® or steel rotor containing workpieces. Vibration within the system, which can be detrimental in other processing steps (e.g., in any immersion process steps performed in the system) is also reduced.

As is best shown in FIGS. 4 and 5, the base of the workpiece support 102 is preferably located close to the front, or the door 104, of the process chamber 100. As a result, the spray arms 108 may rotate 360 degrees around the cantilevered arms 106 of the workpiece support 102 without interference from the workpiece support 102. The support 102 may also be cantilevered off of a support shaft concentric with the shaft 110.

A valve housing 118, having one or more fluid supply valves, is preferably in fluid communication with the rotary union 116 for providing process fluids through the rotary union 116 and into the rotor shaft 110. The process fluids may then sequentially travel through the elbow sections 112, into the spray arms 108, and out of the nozzles 109. One or more fluid supply lines preferably 120 run into the valve housing 118 from a fluid supply source (not shown) for supplying the process fluids to the valve housing 118.

The process chamber 100 may further include, for example, a deionized (DI) water delivery manifold 122 for providing immersion processing of the workpieces 60 with water, liquid chemicals, and/or gas/vapor injected mixtures. One or more sonic transducers 124 (such as megasonic or ultrasonic transducers) may be included for providing sonic energy to the workpieces 60. A gas and/or vapor manifold 126 may be included for providing gas and/or vapor, such as isopropyl alcohol (IPA) vapor, into the process chamber 100 to facilitate surface tension gradient drying (STGD) on the workpiece surfaces. Other processing devices such as manifolds, heaters, UV lights, etc. may also be included in the process chamber 100 for further enhancing processing of the workpieces 60. These additional devices may be connected to the valve housing 118, or to other fluid or electrical source locations, via supply lines or other suitable means.

In use, the door 104 on the process chamber 100 is opened or removed, either manually or by a process robot. Workpieces 60 are then loaded into the grooves or notches in the workpiece support 102, preferably by a process robot. Alternatively, one or more workpiece carriers containing workpieces 60 may be loaded onto the workpiece support 102. The door 104 is then closed or reattached, and preferably, but not necessarily, forms a liquid and/or gas tight seal with the process chamber 100. With the door 104 closed, the process chamber 100 may advantageously provide an entirely closed off environment.

Once the workpieces 60, and/or workpiece carriers, are secured to or placed on the workpiece support 102, the drive motor 114 is turned on to provide rotation to the spray arms 108 via the rotary union 116. The spray arms 108 move 360 degrees around the workpieces 60 on the workpiece support 102. As the workpiece support 102 has one or more cantilevered arms 106, the spray arms 108 can pass beneath the workpieces 60 without contacting the workpiece support 102.

Process fluid is delivered to the valve housing 118 through one or more of the fluid supply lines 120, either before, during, or after activation of the drive motor 114. One or more valves in the valve housing 118 are then opened to release the process fluid, which travels through the rotary union 116 and the rotor shaft 110 into the rotating spray arms 108. The process fluid is then sprayed from the nozzles 109 on the spray arms 108 onto the workpieces 60, which are secured on the workpiece support 102.

As the spray arms 108 revolve entirely around the workpieces 60, the process fluid can contact the entire workpiece surfaces. Thus, the benefits of spin/spray processing, such as excellent process uniformity and promotion of liquid boundary layer exchange at the workpiece surface, are maintained, without having to rotate the workpieces themselves. As a result, damage to the workpieces that may occur during rotation, such as edge particle generation caused by retaining bars on a rotor, is avoided.

Additionally, by spraying the workpieces 60, as opposed to immersing the workpieces in process fluid, a minimal chemical volume is required to process batches of large diameter workpieces. For example, a typical spray processing application requires approximately four liters or less of process fluid to process a typical batch of 200 or 300 mm semiconductor wafers. In comparison, a typical immersion process for the same batch of wafers typically requires approximately 40 liters or more of process fluid.

After the workpieces 60 have been sufficiently sprayed with process fluid(s), various other processing steps may be performed. For example, immersion rinsing may be performed by delivering deionized water into the process chamber 100 via the deionized (DI) water delivery manifold 122. This rinsing step aids in removing excess particles and process fluids from the workpiece surfaces. Once the rinsing step is completed, the DI water may be drained from the process chamber 100 by opening the drain 105 and allowing the water to drain out of the process chamber 100.

Surface tension gradient drying may be used with the immersion rinsing process by introducing isopropyl alcohol (IPA) vapor, and/or another suitable drying vapor or gas, into the process chamber via the gas/vapor manifold 126. When the process chamber 100 begins draining, the alcohol vapor forms a boundary layer at each workpiece liquid interface. The vapor reduces surface tension at the liquid-gas interface. As a result of surface tension effects, the rinsing liquid moves from the interface region down to the bulk of the rinsing liquid, without droplets remaining on the workpiece surface.

When surface tension gradient drying is used, the openings or nozzles 109 in the spray arms 108 may be used to drain water from the water surface, in addition to or as an alternative to draining water from the bottom of the process chamber 100. Draining the water from the water surface helps to prevent the alcohol boundary layer from becoming too thick to be effective in promoting the creation of the surface tension gradient, and can also help to rapidly remove impurities.

Sonic energy, produced by the sonic transducer(s) 124 in the process chamber 100, may also be used with the immersion rinsing process. The sonic transducers 124 are preferably positioned to transmit sonic energy through the liquid in the process chamber 100 to the workpieces 60 immersed in the liquid. This sonic energy aids in removing contaminants from the workpiece surfaces.

The spin axis of the spray arms (as well as the shaft 110) is preferably horizontal. However, a vertical chamber embodiment may also be used.

Thus, while several embodiments have been shown and described, various changes and substitutions may of course be made, without departing from the spirit and scope of the invention. The invention, therefore, should not be limited, except by the following claims and their equivalents.

What is claimed is:

1. A system for processing a workpiece, comprising:
a process chamber;
a workpiece support in the process chamber; and
at least one fluid delivery element in the process chamber, with the fluid delivery element rotatable around the workpiece support for delivering a process fluid toward the workpiece support.

2. The system of claim 1 wherein the fluid delivery element comprises at least one spray arm having a plurality of spray nozzles thereon.

3. The system of claim 2 wherein the fluid delivery element comprises two spray arms located on opposite sides of the workpiece support.

4. The system of claim 1 wherein the workpiece support is attached to an inner wall of the process chamber.

5. The system of claim 1 further comprising a fluid supply system having a fluid supply valve for delivering a process fluid to the fluid delivery element.

6. The system of claim 5 further comprising a rotary union connecting the fluid supply valve to the fluid delivery element, with the rotary union including a hollow shaft through which a process fluid may travel.

7. The system of claim 6 further comprising a fluid delivery line in the hollow shaft through which a process fluid may travel.

8. The system of claim 1 further comprising a sonic transducer in the process chamber for providing sonic energy to the workpiece.

9. The system of claim 1 further comprising a motor linked to the fluid delivery element for rotating the fluid delivery element.

10. The system of claim 1 further comprising at least one of a process gas manifold, a process vapor manifold, and a rinsing liquid manifold in the process chamber for delivering a process gas, a process vapor, and/or a rinsing liquid into the process chamber.

11. The system of claim 1 wherein the process chamber is sealed such that the process chamber is liquid tight.

12. The system of claim 1 further comprising a drain in the process chamber for draining fluid from the process chamber.

13. The system of claim 1 further comprising a removable door on the process chamber.

14. A system for processing a workpiece, comprising:
a process chamber;
a stationary workpiece support in the process chamber;
fluid delivery means in the process chamber for directing a process fluid toward the stationary workpiece support, with the fluid delivery means continuously rotatable around the stationary workpiece support; and
rotation means for rotating the fluid delivery means.

15. The system of claim 14 wherein the stationary workpiece support comprises a cantilevered arm attached to an inner wall of the process chamber.

16. The system of claim 14 wherein the stationary workpiece support includes a plurality of grooves, with each groove configured to receive a workpiece.

17. The system of claim 14 wherein the stationary workpiece support is adapted to support a workpiece carrier.

18. The system of claim 14 wherein the fluid delivery means comprises a plurality of rotatable spray manifolds arranged around the stationary workpiece support for directing a process fluid from a plurality of directions toward the stationary workpiece support.

19. The system of claim 14 wherein the rotation means comprises a hollow motorized rotary shaft, with the rotatable fluid delivery means connected to the rotary shaft.

20. The system of claim 14 further comprising at least one of a process gas delivery means, a process vapor delivery means, and a rinsing liquid delivery means in the process chamber for delivering a process gas, a process vapor, and/or a rinsing liquid into the process chamber.

21. A method of processing a workpiece, comprising the steps of:
placing a workpiece onto a stationary workpiece support in a process chamber;
rotating a fluid delivery element around the workpiece; and
directing a process fluid from the fluid delivery element onto the workpiece while the fluid delivery element rotates.

22. The method of claim 21 further comprising the step of introducing a process gas or vapor into the process chamber.

23. The method of claim 21 further comprising the step of providing sonic energy to the workpiece.

24. The method of claim 21 further comprising the step of sealing the process chamber with a process chamber door.

25. The method of claim 21 further comprising the step of introducing a rinsing liquid into the process chamber to immerse the workpiece in the rinsing liquid.

26. The step of claim 25 further comprising the steps of draining the rinsing fluid from the process chamber and introducing at least one of a drying gas and an organic vapor into the process chamber to facilitate removal of the rinsing liquid from the workpiece.

27. A system for processing workpieces, comprising:
an interface section having multiple workpiece holding positions;
a process section having one or more workpiece processors;
a process robot moveable between the interface section and the process section, for moving workpieces between them;
and with at least one of the workpiece processors comprising:
a process chamber;
a workpiece support in the process chamber; and
a fluid delivery element in the process chamber rotatable around the workpiece support for delivering a process fluid toward the workpiece support.
